(19) United States
(12) Patent Application Publication
(10) Pub. No.: US 2016/0380281 A1
(43) Pub. Date: Dec. 29, 2016

(54) DEVICE AND METHOD FOR CONTROLLING OPERATION OF FUEL CELL SYSTEM

(71) Applicant: Hyundai Motor Company, Seoul (KR)

(72) Inventor: Se Joon Im, Seoul (KR)

(21) Appl. No.: 14/960,420

(22) Filed: Dec. 6, 2015

(30) Foreign Application Priority Data
Jun. 26, 2015 (KR) 10-2015-0090922

(51) Int. Cl. H01M 8/04828; H01M 8/04992; H01M 8/04082; H01M 8/04537; H01M 8/04858

(52) U.S. Cl. CPC H01M 8/0488; H01M 8/04559; H01M 8/04953; H01M 8/04201; H01M 8/04992; H01M 2250/20

(57) ABSTRACT

A device and a method are provided for controlling an operation of a fuel cell system to improve a momentary output of a fuel cell system and decrease a performance deviation between fuel cells. The device momentarily reduces a cell voltage of a fuel cell or changes a fuel cell system to a state close to a shut-down, return the fuel cell system to a normal condition again, and then enable the fuel cell system to be operated normally by applying the “saw-tooth phenomenon” and the “hysteresis phenomenon.” Thus, a momentary output of the fuel cell system is improved to performance of a highest output level or more expressible in a previous state and a performance deviation between fuel cells is decreased.

### CROSS-REFERENCE TO RELATED APPLICATION

This application claims under 35 U.S.C. §119(a) the benefit of Korean Patent Application No. 10-2015-0090922 filed on Jun. 26, 2015, the entire contents of which are incorporated herein by reference.

### BACKGROUND

(a) Technical Field

The present invention relates to a device and a method for controlling an operation of a fuel cell system, and more particularly, to a device and a method for operating a fuel cell system to improve a momentary output of a fuel cell system and decrease a performance deviation between fuel cells.

(b) Background Art

A fuel cell system includes a fuel cell stack that generates electric energy, a fuel supply system that supplies fuel (e.g., hydrogen) to the fuel cell stack, an air supply system that supplies oxygen, which is an oxidizer required for an electro-chemical reaction, in the air to the fuel cell stack, a heat and water management system that adjusts temperature of the fuel cell stack, and the like.

Accordingly, when hydrogen, which is fuel, is supplied to an anode of the fuel cell stack, and air, which is an oxidizer, is supplied to a cathode, the supplied hydrogen is separated into hydrogen ions and electrons by an oxidization reaction of a catalyst layer of the anode in the anode, and in this case, the generated hydrogen ions are supplied to a cathode through a polymer electrolyte layer within a stack and the generated electrons are supplied to the cathode through an external circuit. The supplied oxygen and electrons meet in the cathode to generate oxygen ions by a reduction reaction of the catalyst layer and electricity is generated by a principle, in which the hydrogen ions are combined with oxygen ions, to generate water.

In particular, when a supply of air is interrupted when an open circuit voltage (OCV) generation state of a stack formed by supplying hydrogen to the anode of the fuel cell stack and supplying air to the cathode, a voltage is decreased to a level equivalent to 0 V using a resistor, a battery, a diode, another voltage reducing device, and/or another method, and then an output of the stack is measured by increasing a voltage again, a phenomenon, in which the output of the stack is momentarily improved, is found, and the phenomenon is called a “saw-tooth” phenomenon in the art.

Similarly, a “hysteresis phenomenon” (e.g., when a current is applied to the fuel cell stack in an order of 100 A→200 A→300 A→400 A→300 A→200 A→100 A . . . , higher stack performance is measured in a current decreased section (400→300→200→100 A) than in a current increased section (100→200→300→400 A), and a performance deviation between the respective cells configuring the fuel cell stack is decreased) occurring during a general I-V evaluation is generated.

Through the two phenomena, that is, the saw-tooth phenomenon and the hysteresis phenomenon, performance of the stack may be momentarily improved and a performance deviation between the cells may be decreased when an operation condition, such as a flow rate and a humidification condition, for a material, such as a reaction gas, supplied to the fuel cell stack is not improved, that is, when various operation control conditions, such as a flow rate control and a humidification condition control, for reaction gas including hydrogen and air are not applied.

In general, to improve an output of the fuel cell system and decrease a performance deviation of the cells, various operation conditions may be adjusted, such as a temperature, pressure, and humidification, to an optimal level or an inflow quantity of the reaction gas may be increased.

However, since the operation condition (e.g., increase humidification to a predetermined level or greater) or additionally insert the reaction gas (e.g., increase a flow rate and pressure to a predetermined level or greater) may not be improved over a limited condition of a hardware configuration of the fuel cell system, unless a capacity of the hardware configuration of the corresponding fuel cell system is increased, a value of a predetermined output or greater may not be obtained or a performance deviation may decrease when the performance deviation between the cells is generated.

When a driving time of the fuel cell system elapses, an output of the fuel cell stack itself tends to deteriorate and thus, the fuel cell system experiencing an operation for a predetermined time or more forms an output of a low level compared to initial performance, and a performance deviation between the fuel cells is also increased. When the output of the fuel cell stack is decreased and the deviation between the cells is increased as described above, it may be impossible to secure and adjust normal operation performance including an acceleration/passing characteristic of a fuel cell vehicle by an output limit and the like according to the operation condition of the fuel cell system.

However, the typical fuel cell system does not have a particular alternative for solving the problem other than a general method of stopping an operation of the fuel cell system and performing a separate post-treatment, such as an exchange of a component in the fuel cell system or a performance recovery process for reversible performance deterioration of the fuel cell, and there is a problem in that the processes require a separate process of dismantling and re-installing the fuel cell system, thus decreasing workability.

The above information disclosed in this section is merely for enhancement of understanding of the background of the invention and therefore it may contain information that does not form the prior art that is already known in this country to a person of ordinary skill in the art.

### SUMMARY

The present invention provides a device and a method for controlling an operation of a fuel cell system, which momentarily reduce a cell voltage of a fuel cell or operate a fuel cell system to a state close to a shut-down, return the fuel cell system to a normal condition again, and then enable the fuel cell system to be operated normally by applying the “saw-tooth phenomenon” and the “hysteresis phenomenon”, thereby improving a momentary output of the fuel cell system to performance of a highest output level or more expressible in a previous state and decreasing a performance deviation between fuel cells.

In one aspect, the present invention provides a device for controlling an operation of a fuel cell system that may include: a detection unit configured to determine a time, at which it is required to improve performance of a fuel cell and decrease a performance deviation between cells; a controller configured to adjust an operation mode of the fuel cell system to an auxiliary power mode and simultaneously adjust a cell voltage of the fuel cell to be reduced to about 0 V at the time, at which it is required to improve the performance of the fuel cell and decrease the performance deviation between the cells, and then adjust the operation mode of the fuel cell system to a normal operation mode again; and a voltage reducing device configured to reduce the cell voltage of the fuel cell to about 0 V by a command of the controller.

In an exemplary embodiment, when a total voltage of the fuel cells for each operation current of the fuel cell system (e.g., a total voltage of fuel cells for each operation current for high-output travelling of the fuel cell vehicle) is equal to or less than a threshold value, and an average voltage of the fuel cells is equal to or less than a threshold value, the detection unit may be configured to determine that it is required to improve the performance of the fuel cell at this time.

In addition, when a cell deviation, which is a difference between an average voltage of the fuel cells and a minimum cell voltage, is equal to or greater than a threshold value, the detection unit may be configured to determine a required decrease of the performance deviation between the cells at this time. Any one selected from among a resistor, a diode, and a battery which reduce the voltage of the fuel cell to about 0 V by consuming a current of the cell of the fuel cell after blocking air for a cathode of the fuel cell, may be adopted as the voltage reducing device.

A hydrogen purge line for a cathode, which reduces a cell voltage to about 0 V by decreasing an air supply flow rate for the cathode of the fuel cell to a minimum flow rate range, and simultaneously supplying hydrogen to the cathode, may be adopted as the voltage reducing device. An additional power supply, which reduces a voltage of the fuel cell to a predetermined level or less by applying a high current to a fuel cell during a normal operation of the fuel cell, may be adopted as the voltage reducing device.

In another aspect, the present invention provides a method for controlling an operation of a fuel cell system that may include: determining a time, at which it is required to improve performance of a fuel cell and decrease a performance deviation between cells; adjusting an operation mode of the fuel cell system to an auxiliary power only mode and simultaneously adjusting a cell voltage of the fuel cell to be reduced to about 0 V at the time, at which it is required to improve the performance of the fuel cell and decrease the performance deviation between the cells; and adjusting the operation mode of the fuel cell system to a normal operation mode.

When a total voltage of the fuel cells for each operation current of the fuel cell system (e.g., a total voltage of fuel cells for each operation current for high-output travelling of the fuel cell vehicle) is equal to or less than a threshold value, and an average voltage of the fuel cells is equal to or less than a threshold value, it may be determined that it is required to improve the performance of the fuel cell at this time.

When a cell deviation, which is a difference between an average voltage of the fuel cells and a minimum cell voltage, is equal to or greater than a threshold value a requirement of a decrease to the performance deviation between the cells may be determined at this time. The adjustment of the cell voltage of the fuel cell may be performed by consuming, by any one selected from among a resistor, a diode, and a battery, a current of the fuel cell after blocking air for a cathode of the fuel cell.

In addition, the adjustment of the voltage of the cell of the fuel cell may be performed by decreasing an air supply flow rate for the cathode of the fuel cell to a minimum flow rate range, and simultaneously supplying hydrogen to the cathode using a hydrogen purge line for the cathode. The adjustment of the cell voltage of the fuel cell may also be performed by reducing a voltage of the fuel cell to a predetermined level or less by applying a high current to a fuel cell during a normal operation of the fuel cell.

Through the aforementioned technical solutions, the present invention provides the effects below.

According to the present invention, it may be possible to improve a momentary output of the fuel cell system to performance of a maximum output level or greater expressible in a previous state and decrease a performance deviation between the fuel cells by momentarily reducing a cell voltage of the fuel cell to a specific voltage (e.g., about 0 V) at a time, at which it is required to improve performance of the fuel cell and decrease a performance deviation between the cells, and then enabling the fuel cell system to be operated normally by returning the fuel cell system to a normal condition again by applying the “saw-tooth phenomenon” and the “hysteresis phenomenon”.

In other words, it may be possible to improve performance (e.g., output) of the fuel cell and decrease a performance deviation between the fuel cells at a time, at which the performance of the fuel cell including a plurality of fuel cells is decreased to a limited value or less or a performance deviation between the fuel cells is increased, such as an operation section requiring a high output in a short period of time including a momentary sudden acceleration, or a weak operation condition of the fuel cell (e.g., a low temperature or a high temperature of the fuel cell, a low humidity condition, a hydrogen concentration decrease and dry-out condition, such as an idle operation for a long time, and an initial time of re-starting after a fuel cell vehicle stops for a long time).

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a flow chart illustrating a method of controlling an operation of a fuel cell system according to an exemplary embodiment of the present invention;

FIGS. 2 to 4 are graphs illustrating a comparison of measured performance of a fuel cell stack when a related art (the Comparative Example) and the present invention (an exemplary embodiment) are applied; and

FIGS. 5 and 6A-6B are graphs illustrating a comparison of measured cell performance of a fuel cell when a related art (an initial time of re-starting after a stop for a long time) and the present invention (re-start after decreasing a cell voltage) are applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

The present invention places emphasis on promoting an improvement of a momentary output of a fuel cell system and decreasing a performance deviation in a situation where the performance deviation between fuel cells is increased at a time at which the improvement of the performance of the fuel cell and the decrease of the performance deviation between the fuel cells are required without changing or improving various forms of operation conditions, such as supplying a separate material to a fuel cell stack, adjusting a humidification quantity for the fuel cell stack, or pressurizing hydrogen or air for the fuel cell stack.

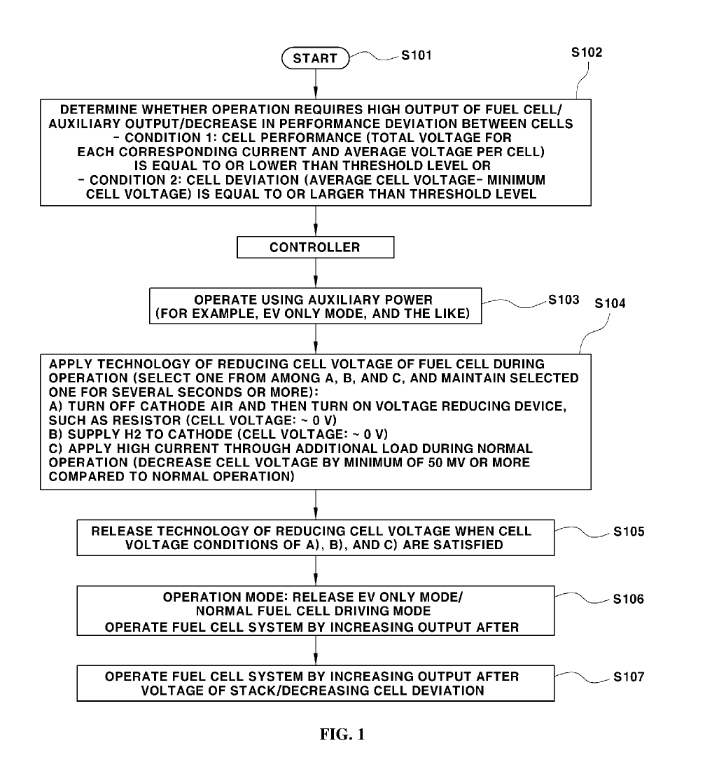

FIG. 1 is a flow chart illustrating a method of controlling an operation of a fuel cell system according to an exemplary embodiment of the present invention. First, to adjust an operation of a fuel cell system of the present invention, a controller may be configured to detect whether a fuel cell vehicle is started, detect operation information, or detect whether a driver enters the vehicle (S101).

More particularly, the fuel cell system may include a fuel cell stack configured to generate electric energy, a fuel supply system configured to supply fuel (e.g., hydrogen) to the fuel cell stack, an air supply system configured to supply oxygen, which is an oxidizer required for an electro-chemical reaction, in the air to the fuel cell stack, a heat and water management system configured to adjust an operation temperature of the fuel cell stack, and the like. When the fuel cell system is mounted in the fuel cell vehicle, a controller may be configured to detect whether a fuel cell vehicle is started, operation information, or whether a driver enters the vehicle to operate a fuel cell system of the present invention.

Further, a detection unit (e.g., a sensor) may be configured to determine a time, at which a fuel cell performance improvement and a performance deviation decrease between cells is required (S102). In particular, when the cell performance of the fuel cell is equal to or less than a threshold value, the detection unit may be configured to determine the improvement requirement of fuel cell performance at this time. In other words, when a total voltage of the fuel cell for each operation current of the fuel cell system (e.g., a total voltage of the fuel cells for each operation current for high-output travelling of the fuel cell vehicle) is equal to or less than a threshold value, and an average voltage of the fuel cells is equal to or less than a threshold value, the detection unit may be configured to determine the improvement requirement of the fuel cell performance at this time.

When a voltage deviation between the fuel cells is equal to or less than a threshold value, the detection unit executed by the controller may be configured to determine a requirement to decrease the performance deviation between cells at this time. In other words, when a cell deviation, which is a difference between the average voltage of the fuel cells and a minimum cell voltage, is equal to or greater than a threshold value, the detection unit may be configured to determine a requirement to decrease the performance deviation between cells at this time. In particular, the time, at which it is required to improve fuel cell performance or the time, at which it is required to decrease the voltage deviation between fuel cells may be substantially generated at the time of starting after the fuel cell vehicle is parked for a substantial period of time, in an acceleration mode after idle travelling for a substantial period of time, and in a passing acceleration mode during general travelling.

In response to determining the requirement to improve fuel cell performance at this time, at which the cell performance of the fuel cell is equal to or less than the threshold value, or the requirement to decrease the performance deviation between cells at this time, at which the voltage deviation between the fuel cells is equal to or less than the predetermined value, the controller may be configured to switch or adjust an operation mode of the fuel cell system to be changed to an auxiliary power mode (e.g., travelling in an electric vehicle (EV) mode using battery power of the fuel cell vehicle) using auxiliary power (S103), and simultaneously may be configured to adjust a cell voltage of the fuel cell to be decreased to a specific voltage (e.g., a level of about 0.1 V or 0 V) (S104). In particular, a voltage reducing device may be configured to reduce the cell voltage of the fuel cell to about 0 V by a command of the controller.

As a first exemplary embodiment of the voltage reducing device, any one selected from among a resistor, a diode, and a battery reducing the voltage of the fuel cell to reduce a cell voltage of the fuel cell to a specific voltage or less may be used. The selected device from among the resistor, the diode, and the battery may consume a current of the fuel cell after air is blocked for a cathode of the fuel cell, to reduce the voltage of the fuel cell to the specific voltage or less.

As a second exemplary embodiment of the voltage reducing device, a hydrogen purge line for the cathode, configured to reduce the cell voltage to a specific voltage (e.g., a level of about 0.1 V or 0 V), may be adopted, and the voltage of the fuel cell may be reduced to the specific voltage or less by reducing an air supply flow rate for the cathode of the fuel cell to a minimum flow rate range and simultaneously supplying hydrogen, not air, to the cathode using the hydrogen purge line for the cathode.

More particularly, in a normal operation state of the fuel cell system, electricity may be generated by supplying air to the cathode of the fuel cell and supplying hydrogen to an anode. To reduce the voltage of the fuel cell to the specific voltage or less, hydrogen may be supplied to the cathode by connecting the separate hydrogen purge line for the cathode to the cathode, to decrease a reaction for generating electricity of the fuel cell and thus the voltage of the fuel cell may be reduced to, e.g., a level of about 0.1 V or 0 V.

As a third exemplary embodiment of the voltage reducing device, an additional power supply, configured to reduce the voltage of the fuel cell to a predetermined level or less by applying a high current to the fuel cell during the normal operation of the fuel cell, may be used, and by using the additional power, the voltage of the fuel cell may be decreased by a minimum of about 50 mA or more compared to the normal operation.

Furthermore, when the voltage of the fuel cell is decreased to the specific voltage or less by the voltage reducing device, a voltage reducing process of the voltage reducing device according to each exemplary embodiment may be released (S105). Simultaneously, the controller may be configured to change the operation mode of the fuel cell system from the auxiliary power supply mode to the normal operation mode (S106), and in this case, in response to determining a requirement to improve the output performance of the fuel cell and to decrease the cell voltage deviation after the voltage of the fuel cell stack, the aforementioned process may be repeatedly performed again (S107).

According to the device and the method for controlling the operation of the fuel cell system of the present invention, when an output of the fuel cell stack is momentarily decreased (e.g., reversible performance deterioration) by a previous operation state of the fuel cell system, a performance deviation between the cells may be increased to a specific level or greater, or a momentary performance improvement, such as sudden acceleration including passing acceleration, is required by a method by an operation of a driver, a method using a vehicle diagnosing/controlling device, and a method of monitoring an operation state of a vehicle, it may be possible to improve a momentary output of the fuel cell system and decrease a performance deviation between the fuel cells without separately modifying/supplementing a hardware element, thereby enabling the fuel cell vehicle to be stably operated.

When the device and the method for controlling the operation of the fuel cell system of the present invention are utilized, it may be possible to expect an effect of greater performance improvement particularly when performance of the fuel cell stack deteriorates by an abnormal operation condition, not a normal operation state, and the conditions are described below.

First, a case of irreversible deterioration, in which deterioration of performance of the fuel cell stack/a performance deviation between the cells is severe, after the fuel cell system is driven for a predetermined time or greater and after an abnormal state, which may damage the stack.

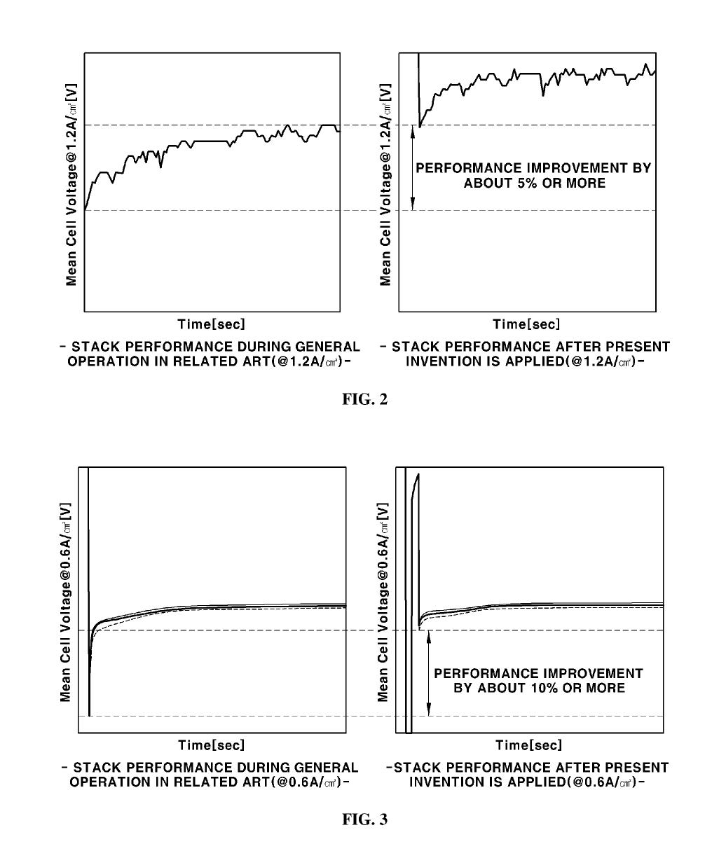

Second, when reversible performance deterioration and a performance deviation between the cells are severe at an initial time of a starting/operation after the vehicle is parked for a substantial period of time, and by a hydrogen concentration decrease or a stack dry-out based on downhill road travelling for a substantial period time, a maintenance of a high temperature and low humidity operation, and a maintenance of a low speed idle operation when the fuel cell stack reversibly deteriorates after the abnormal operation condition. In particular, performance of the fuel cell stack may be measured using general performance measurement equipment and compared when the methods of changing the operation of the fuel cell system according to the present invention and the related art are applied, and a result thereof is illustrated in FIGS. 2 to 4.

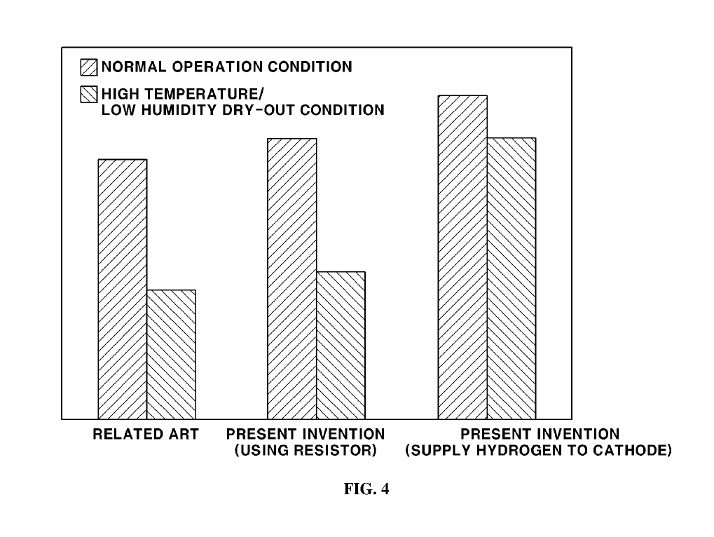

Referring to FIG. 2, when an output of the fuel cell stack is compared between a case applying the related art, in which an operation current is momentarily and immediately increased to a high output section (e.g., about 1.2 A/cm²) in a general operation section and a case applying the method of the present invention, in which a stack voltage is reduced to about 0 V before an increase in a current, it may be seen that the output of the stack is improved by about 5% or greater in the present invention compared to the related art. Referring to FIG. 3, it may be seen that in a case of city travelling for several minutes or more (e.g., a low output operation: about 0.6 A/cm²), the output of the stack may be improved by about 10% or more in the present invention compared to the related art.

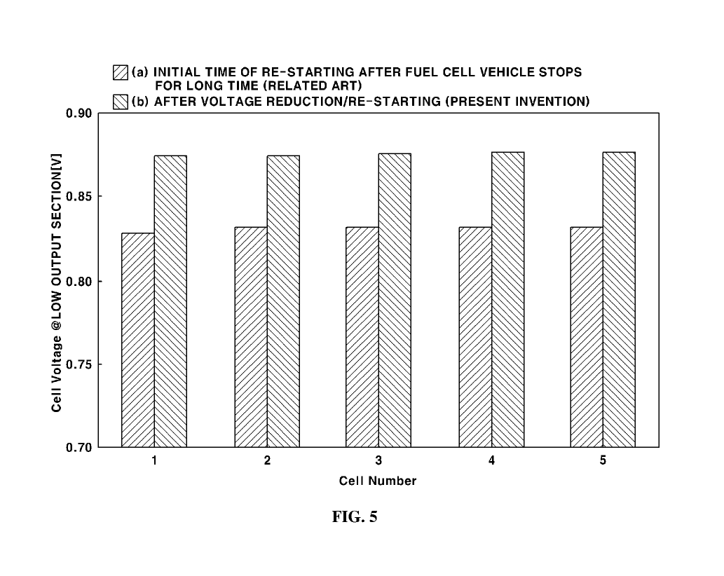

Referring to FIG. 4, it may be seen that when reversible performance deterioration is sharply incurred by the dry-out phenomenon of the fuel cell according to the maintenance of the idle operation or stack durability performance deteriorates by the operation for a substantial period of time, the present invention, which reduces a cell voltage of the fuel cell to about 0 V by supplying hydrogen to the resistor or the anode and then re-starts the vehicle, exhibits an effect of further improving an output (about 5 to 10% or more) compared to the related art. In particular, as another test example of the present invention, a cell voltage in a low output section may be measured when the fuel cell vehicle stops for a substantial period of time and then is re-started, and a result thereof is illustrated in FIG. 5.

FIG. 5 is a result of a measurement of performance of the fuel cell configuring the stack in a low output section, in which a current density is equal to or less than 50 mA/^{cm2}, when the fuel cell vehicle stops for a predetermined time or more and then is in an initial time (e.g., low temperature) of re-starting, and (a) represents cell performance after the fuel cell vehicle stops for a substantial period of time in the related art, and (b) represents cell performance when a cell voltage is reduced to 0.1 V or less using the method of reducing the voltage of the present invention and then the fuel cell vehicle is re-started.

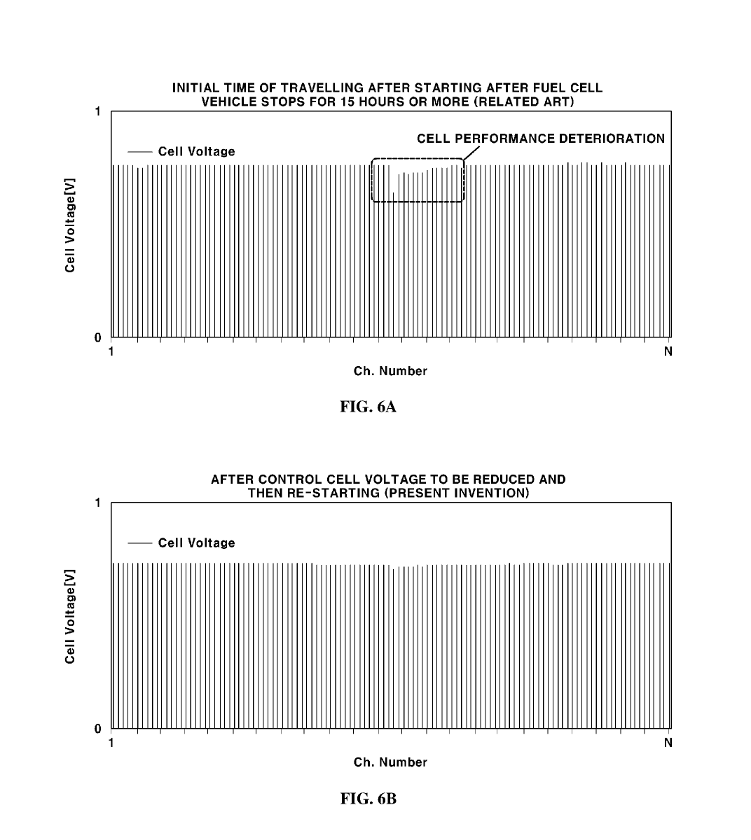

Referring to FIG. 5, it may be seen that performance of the fuel cell stack is slightly reduced compared to that of the normal state at the initial time of the starting after the fuel cell vehicle stops for a substantial period of time due to dryness within the cell of the fuel cell stack and an inflow of air into the fuel cell stack while the fuel cell vehicle stops for a substantial period of time, and performance itself is low and a performance deviation between the cells tends to be severe in the fuel cell stack, in which several hundreds or more of cells are stacked, but in the present invention, when a voltage of the fuel cell stack is reduced to a predetermined level or greater by reducing a voltage through the voltage reducing means (e.g., reducing a voltage using the resistor) as described above, and then the fuel cell vehicle is re-started, cell performance of the fuel cell may be improved by about 5% or more compared to the related art. As another test example of the present invention, cell performance may be measured when the fuel cell vehicle stops for a substantial period of time and then is in an initial time of re-starting, and a result thereof is illustrated in FIG. 6.

FIGS. 6A and 6B illustrate a result of a measurement of cell performance of the fuel cell stack when the fuel cell vehicle stops for 15 hours or more and then is in the initial time of the re-starting. In particular, FIG. 6A represents cell performance in the related art when performance is measured when the fuel cell vehicle is re-started after a stop for a substantial period of time without any measures, and FIG. 6B represents cell performance when a voltage of the fuel cell stack is reduced to a predetermined level or less using the method of reducing the voltage of the present invention and then the fuel cell vehicle is re-started.

Referring to FIGS. 6A-6, it may be seen that in the related art, performance deteriorates (indicated with a hidden line box) in some cells, so that a performance deviation between the cells has a considerable large value, but in the present invention, it may be possible to solve a voltage deviation of about 0.1 V or greater between the cells.

As described above, when the method of improving performance of the fuel cell system of the present invention is utilized, it may be possible to improve an output of the fuel cell stack and decrease a performance deviation between the cells in an operation section requiring a high output momentarily or for a short period of time and when a performance deviation between the fuel cells of the stack is increased, thereby enabling the fuel cell vehicle to be operated more stably. A performance deviation between the cells generated in a relatively weak operation condition may be decreased, and thus, it may be possible to prevent performance of the fuel cell stack from being abnormally decreased/deteriorating and improve an output when the fuel cell stack deteriorates, thereby improving durability performance of the fuel cell.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A device for controlling an operation of a fuel cell system, comprising:
a detection unit configured to determine a time, at which improvement of a performance of a fuel cell and a decrease a performance deviation between cells are required;
a controller configured to change an operation mode of the fuel cell system to an auxiliary power mode and simultaneously adjust a cell voltage of the fuel cell to be reduced to a specific voltage or less at the time, improvement of a performance of a fuel cell and a decrease a performance deviation between cells are required, and then change the operation mode of the fuel cell system to a normal operation mode again; and
a voltage reducing device configured to reduce the cell voltage of the fuel cell to the specific voltage or greater by a command of the controller.

2. The device of claim 1, wherein when a total voltage of the fuel cells for each operation current of the fuel cell system is equal to or less than a threshold value, and an average voltage of the fuel cells is equal to or less than a threshold value, the detection unit is configured to determine a requirement to improve the performance of the fuel cell at this time.

3. The device of claim 1, wherein when a cell deviation, which is a difference between an average voltage of the fuel cells and a minimum cell voltage, is equal to or greater than a threshold value, the detection unit is configured to determine a requirement to decrease the performance deviation between the cells at this time.

4. The device of claim 1, wherein any one selected from the group consisting of: a resistor, a diode, and a battery, which reduce the voltage of the fuel cell to the specific voltage or less by consuming a current of the fuel cell after blocking air for a cathode of the fuel cell, is adopted as the voltage reducing device.

5. The device of claim 1, wherein a hydrogen purge line for a cathode is adopted as the voltage reducing device and wherein the hydrogen purge line in configured to reduce the cell voltage to a specific voltage or less by decreasing an air supply flow rate for the cathode of the fuel cell to a minimum flow rate range, and simultaneously supplying hydrogen to the cathode.

6. The device of claim 1, wherein an additional power supply is adopted as the voltage reducing device and wherein the additional power supply is configured to reduce the cell voltage of the fuel cell to a predetermined level or less by applying a high current to a fuel cell during a normal operation of the fuel cell.

7. A method for controlling an operation of a fuel cell system, comprising:
determining, by a sensor, a time, at which improvement of a performance of a fuel cell and a decrease a performance deviation between cells are required;
changing, by a controller, an operation mode of the fuel cell system to an auxiliary power mode and simultaneously adjusting a cell voltage of the fuel cell to be reduced to a specific voltage or less at the time, improvement of a performance of a fuel cell and a decrease a performance deviation between cells are required; and
when the operation mode is changed to the auxiliary power mode, adjusting, by the controller, the operation mode of the fuel cell system to a normal operation mode.

8. The method of claim 7, wherein when a total voltage of the fuel cells for each operation current of the fuel cell system is equal to or less than a threshold value, and an average voltage of the fuel cells is equal to or less than a threshold value a requirement to improve the performance of the fuel cell at this time is determined.

9. The method of claim 7, wherein when a cell deviation, which is a difference between an average voltage of the fuel cells and a minimum cell voltage, is equal to or greater than a threshold value a requirement to decrease the performance deviation between the cells at this time is determined.

10. The method of claim 7, wherein the adjusting of the cell voltage of the fuel cell to be reduced to the specific voltage or less is performed by consuming, by any one selected from the group consisting of: a resistor, a diode, and a battery, a current of the fuel cell after blocking air for a cathode of the fuel cell.

11. The method of claim 7, wherein the adjusting of the cell voltage of the fuel cell to be reduced to the specific voltage or less is performed by decreasing an air supply flow rate for the cathode of the fuel cell to a minimum flow rate range, and simultaneously supplying hydrogen to the cathode using a hydrogen purge line for the cathode.

12. The method of claim 7, wherein the adjusting of the cell voltage of the fuel cell to be reduced to the specific voltage or less is performed by a process of reducing a cell voltage of the fuel cell to a predetermined level or less by applying a high current to a fuel cell during a normal operation of the fuel cell.
